(19) United States
(12) Patent Application Publication
(10) Pub. No.: US 2020/0401218 A1
(43) Pub. Date: Dec. 24, 2020

(54) COMBINED GAZE AND TOUCH INPUT FOR DEVICE OPERATION

(71) Applicant: Synaptics Incorporated, San Jose, CA (US)

(72) Inventors: Matthew Joseph CAMILLERI, Davis, CA (US); Tyson Ryo MIKUNI, San Jose, CA (US); Mohamed Ashraf SHEIK-NAINAR, San Jose, CA (US); Do Hee KIM, San Jose, CA (US); Andrew Chen Chou HSU, San Carlos, CA (US)

(21) Appl. No.: 16/445,092

(22) Filed: Jun. 18, 2019

(51) Int. Cl. G06F 3/01; G06F 3/0354; G06F 3/038

(52) U.S. Cl. CPC G06F 3/013; G06F 3/038; G06F 3/03547

(57) ABSTRACT

Systems and methods for performing a device operation in response to a touch input and based on a user's gaze are described. An example device includes a touch sensor configured to sense a touch input from a user, a gaze sensor configured to capture gaze information regarding a user's gaze, one or more processors, and a memory coupled to the one or more processors. The memory stores instructions that, when executed by the one or more processors, cause the device to determine a feature of the user's gaze based on the captured gaze information, and disregard the touch input based on the feature of the user's gaze.

### TECHNICAL FIELD

The present embodiments relate generally to gaze and touch sensing, and specifically to operation of a device based on a combined gaze and touch input.

### BACKGROUND

Many user devices (such as desktop computers, laptop computers, smartphones, tablets, or other personal or mobile computing devices) include or are coupled to one or more touch sensors (such as a touchpad, mouse, keyboard, etc.). The one or more touch sensors may be intentionally used to control the device. For example, a touchpad may be used to control a cursor of a graphical user interface (GUI) on a display of the device.

Incidental interaction with a touch sensor may cause the device to perform an unintentional operation. For example, a user incidentally tapping or swiping the touchpad (such as resting a palm on the touchpad) may cause a laptop computer to unintentionally close a program, switch windows in a GUI, or move the cursor to a different region of the display. It may be desirable to prevent such unintentional operations caused from incidentally interacting with the touch sensor.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An example device for performing a device operation in response to a touch input and based on a user's gaze is described. The example device includes a touch sensor configured to sense a touch input from a user, a gaze sensor configured to capture gaze information regarding a user's gaze, one or more processors, and a memory coupled to the one or more processors. The memory stores instructions that, when executed by the one or more processors, cause the device to determine a feature of the user's gaze based on the captured gaze information, and disregard the touch input based on the feature of the user's gaze.

An example non-transitory, computer-readable medium including instructions is also described. The instructions, when executed by one or more processors of a device, cause the device to sense, by a touch sensor, a touch input from a user, capture, by a gaze sensor, gaze information regarding a user's gaze, determine a feature of the user's gaze based on the captured information, and disregard the touch input based on the feature of the user's gaze.

An example method is also described. The method includes sensing, by a touch sensor, a touch input from a user, capturing, by a gaze sensor, gaze information regarding a user's gaze, determining a feature of the user's gaze based on the captured information, and disregarding the touch input based on the feature of the user's gaze.

### BRIEF DESCRIPTION OF THE DRAWINGS

The present embodiments are illustrated by way of example and are not intended to be limited by the figures of the accompanying drawings.

FIG. 1 illustrates a block diagram of an example device for which the present embodiments may be implemented.

FIG. 2 illustrates an example configuration of a touch sensor coupled to the processing system of a device.

FIG. 3A illustrates an example configuration of a device with a touch sensor separated from a display, where a user is gazing at a region of the display.

FIG. 3B illustrates an example configuration of the device in FIG. 3A, where the user is gazing at a different region of the display.

FIG. 4 is an illustrative flow chart of an example operation to selectively perform one or more operations based on a user's gaze.

### DETAILED DESCRIPTION

A touch sensor for a user device may sense an incidental touch from the user and cause unintentional functions to be performed. An example device includes a laptop computer with a keyboard and a touchpad below the keyboard. While a user is typing to insert text in a word processing window and the cursor hovers over the close window button, a user may incidentally touch the touchpad, and the laptop computer may close the word processing program. Another example device includes a smartphone or tablet including a touch display. When a user is typing on a soft keyboard or otherwise interacting with the display, the user's palm may incidentally touch the edge of the display or a home button. As a result, the smartphone or tablet may go to the home screen or otherwise interfere with the user's intended actions.

A device may attempt to differentiate between intentional touches and unintentional touches based on characteristics of the touch. A device may also attempt to prevent incidental touches from causing unintended operations by desensitizing a touch sensor in some scenarios. For example, a laptop computer may reduce the sensitivity of the touchpad when a user is typing or otherwise using a keypad or keyboard of the laptop computer. However, incidental touches may still occur and cause unintentional actions by the device.

In some aspects of the present disclosure, a device may include a gaze sensor to determine where the user is looking (a user's gaze location). For example, the gaze sensor may be used in determining where on a display a user is gazing. The device may use the determined location of the user's gaze to determine if a touch is intentional. For example, if a cursor is hovering over a button in a GUI on a display and the device determines that the user is not looking at the region of the display including the button and the cursor, the device may determine that the touch is unintentional. As a result, the device may not perform the operation associated with the button. In general, a device may be configured to selectively perform one or more operations based on a user's gaze and in response to a touch input. For example, a GUI operation associated with a location of the user's gaze on the display may be performed in response to a touch input. In another example, the device may disregard the touch input based on the user's gaze, adjust a device or display parameter based on the user's gaze, or prevent a device function from being performed based on a user's gaze.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory. The interconnection between circuit elements or software blocks may be shown as buses or as single signal lines. Each of the buses may alternatively be a single signal line, and each of the single signal lines may alternatively be buses, and a single line or bus may represent any one or more of a myriad of physical or logical mechanisms for communication between components.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described. The non-transitory computer-readable storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors. The term “processor,” as used herein may refer to any general purpose processor, conventional processor, controller, microcontroller, and/or state machine capable of executing scripts or instructions of one or more software programs stored in memory.

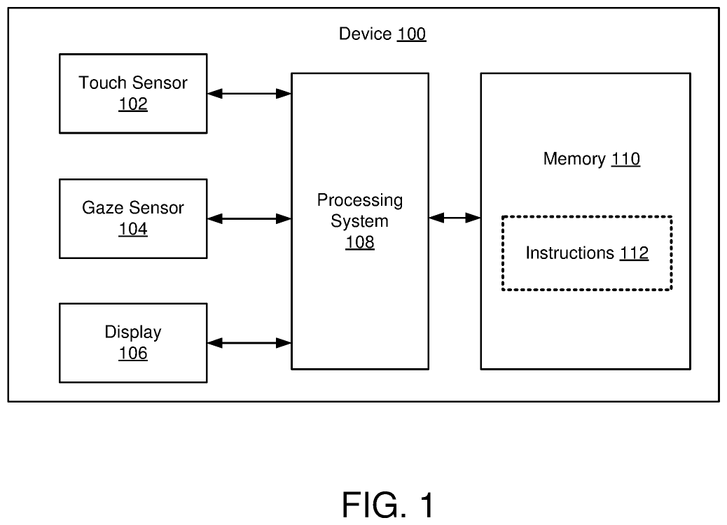

Turning now to the figures, FIG. 1 is a block diagram of an example device 100, in accordance with some embodiments. The example device 100 may include or be coupled to a touch sensor 102, a gaze sensor 104, and a display 106. The example device 100 may also include a processing system 108 and a memory 110 including instructions 112. The device 100 may include additional features or components not shown. In one example, the device 100 may include or be coupled to additional input/output components, such as a microphone, speaker, keyboard, infrared (IR) transmitter, etc. In another example, a wireless interface, which may include a number of transceivers and a baseband processor, may be included for a wireless communication device. In another example, one or more motion sensors (such as a gyroscope) may be included in the device 100.

An example device 100 may include a laptop computer, desktop computer, smartphone, tablet, or other suitable user devices including or coupled to a touch sensor 102 and a gaze sensor 104. While the example device 100 is used in describing example aspects of the disclosure, the disclosure is not limited to any specific example device, including the example device 100.

The touch sensor 102 may be a touchpad, mouse, keypad, touch-sensitive display, or other suitable sensor for determining a user input to control the device 100. The gaze sensor 104 may be a visible light camera sensor, an IR camera sensor (such as for depth sensing or mapping), or other suitable sensors for determining a location, a duration, or other features of a user's gaze. The display 106 may be a monitor coupled to the device 100, an LED (such as an AMOLED) display, or other suitable display integrated into the device 100. The gaze sensor 104 may be configured to determine the location on the display 106 of the user's gaze and the duration of a user's gaze at the location on the display 106.

The memory 110 may be a non-transient or non-transitory computer readable medium storing computer-executable instructions 112 to perform all or a portion of one or more operations described in this disclosure. For example, the instructions 112 may be executed to cause the device 100 to perform one or more operations based on a user's gaze and in response to a touch input, such as determining whether a touch input to the touch sensor 102 is to be ignored or disregarded based on a gaze location on the display 106 determined by the gaze sensor 106. The memory 110 may also include instructions for other operations of the device 100.

The processing system 108 may be one or more processors capable of executing scripts or instructions of one or more software programs (such as instructions 112) stored within the memory 110. In additional or alternative aspects, the processing system 108 may include integrated circuits or other hardware to perform functions or operations without the use of software. While shown to be coupled to each other via the processing system 108 in the example device 100, the processing system 108, the memory 110, the touch sensor 102, the gaze sensor 104, and the display 106 may be coupled to one another in various arrangements. For example, the processing system 108, the memory 110, the touch sensor 102, the gaze sensor 104, and/or the display 106 may be coupled to each other via one or more local buses (not shown for simplicity).

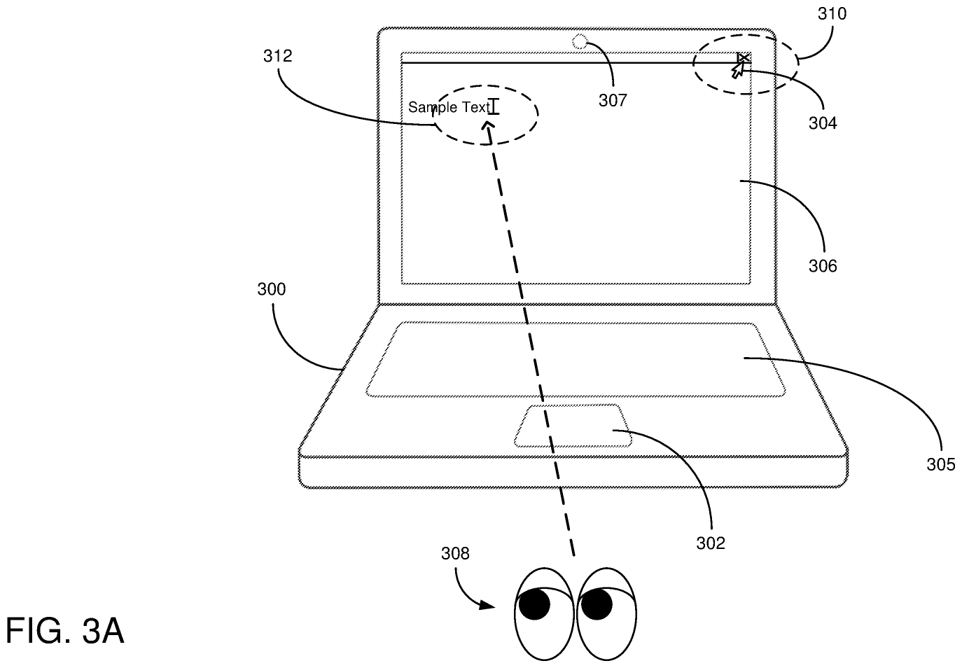

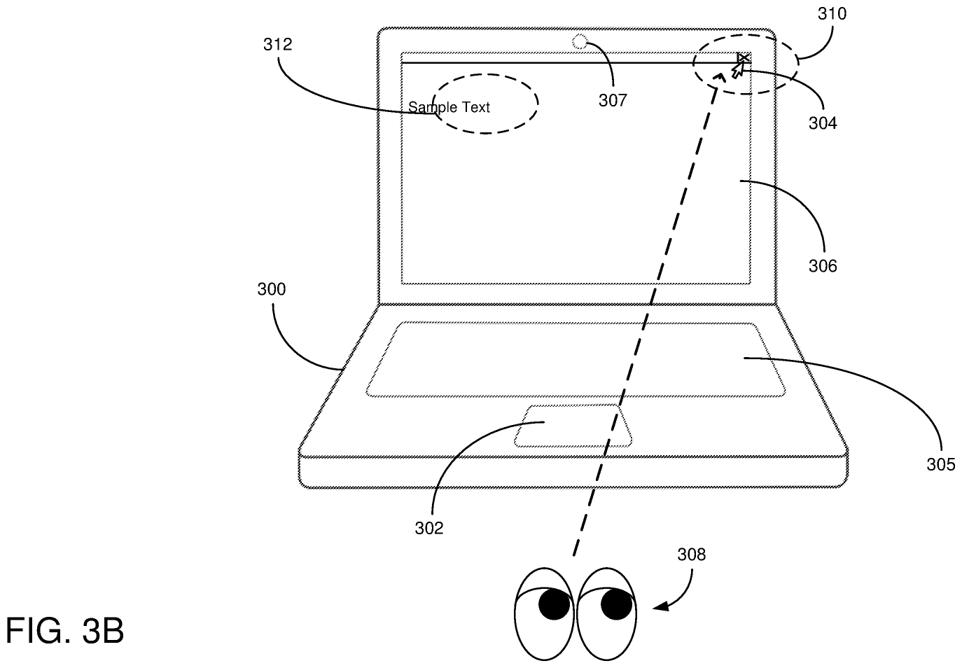

The following examples are described regarding the device 100 (and the device 300 in FIGS. 3A and 3B) performing one or more operations. The device 100 or 300 performing an operation may correspond to one or more device components performing the operation. For example, the device 100 or 300 determining a type of touch may correspond to the processing system 108 executing instructions 112 to perform the determination. In another example, the processing system 108 may include one or more integrated circuits to perform the determination. In a further example, the processing system 108 may include a combination of dedicated hardware and processors executing software to perform one or more operations. The examples are provided solely to illustrate aspects of the disclosure, and any suitable device or device components may be used to perform the operations.

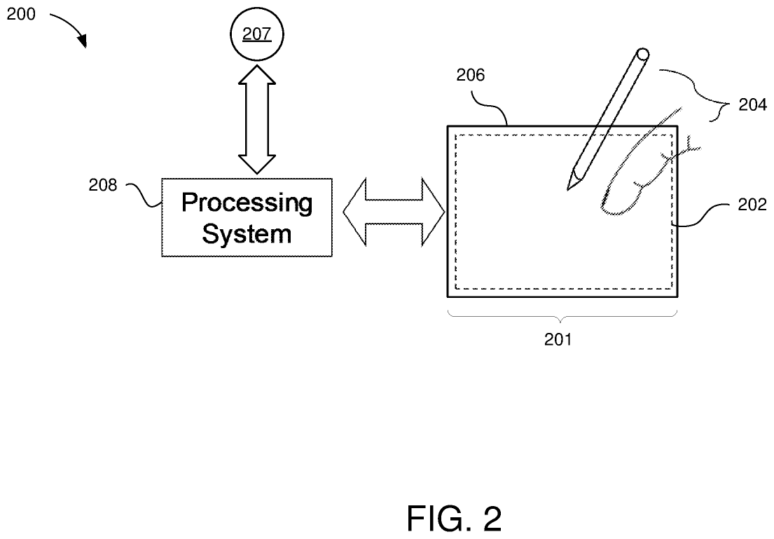

FIG. 2 illustrates an example configuration 200 of an input device 201 coupled to a processing system 208. The processing system 208 may be an example embodiment of the processing system 108 of FIG. 1. As illustrated, the input device 201 may be integrated with a display 206. The display 206 may be any type of dynamic display capable of displaying a visual interface (such as a graphical user interface (GUI)) to a user, and may include any type of light emitting diode (LED), organic LED (OLED), cathode ray tube (CRT), liquid crystal display (LCD), plasma, electroluminescence (EL), or other display technology.

The input device 201 may include a touch sensor (such as a touch sensor 102 in FIG. 1). In the example of FIG. 2, the input device 201 is a touch-sensitive display including a sensing region 202 for the touch sensor to identify touches by input objects 204. Input objects 204 may include fingers and styli, as shown in FIG. 2, or other suitable objects. Sensing region 202 may encompass any space above, around, in and/or near the input device 201 in which the processing system 208 is able to detect user input (e.g., user input provided by one or more input objects 204). The sizes, shapes, and locations of particular sensing regions may vary widely from embodiment to embodiment.

In some embodiments, the sensing region 202 extends from a surface of the input device 201 in one or more directions into space until signal-to-noise ratios prevent sufficiently accurate object detection. The distance to which this sensing region 202 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 201. For example, hovering a finger or palm over a portion of a touch sensor may be identified as a touch by the processing system 208.

For sensing, the input device 201 may include substantially transparent sensor electrodes overlaying the display 206 and thus provide a touch screen interface. As another example, the input device 201 may comprise photosensors in or under the display 206 and provide an optical sensing interface. The input device 201 may utilize any suitable sensing technology to detect user input, including capacitive, optical, elastive, resistive, inductive, magnetic, acoustic, and ultrasonic sensing technologies.

The processing system 208 is further coupled to a gaze sensor 207. The gaze sensor 207 may be an example embodiment of the gaze sensor 104 of FIG. 1, and may be used to determine where a user is looking on the display 206 (or other features of the user's gaze) while interacting with the input device 201. In some aspects, the gaze sensor 207 may be configured to detect the surface of a user's eyes and identify the ridge of an eyeball associated with the lens. The processing system 208 may then determine the location of the lens in reference to the eyeball to determine where the user is gazing. In some other aspects, the gaze sensor 207 may be configured to detect the location and size of the eyelids in relation to the eyes (such as based on the ridge of the eyelid. For example, as a user looks down, the eyelids may cover more of the eye from the perspective of the gaze sensor (such as the user nodding his or her head down, or the eyelids extending over more of the eye). In this manner, the processing system 208 may determine a region of the display 206 at which the user is gazing, may determine whether the user is gazing at the display 206, and/or may determine where the user is gazing outside of the display 206.

One implementation of a gaze sensor 207 includes a CMOS sensor configured to detect IR signals. An IR transmitter (which may be included or separate from the gaze sensor 207) may transmit IR signals in a field of transmission toward and including a user. The IR signals may reflect off the user, and the CMOS sensor receives those reflections. Based on time of flight and/or intensity of the IR signals received by the CMOS sensor, the device may determine depths and contours of the user, including contours of the eyes to determine a gaze location of the user.

Another example gaze sensor 207 includes a sensor to track head movement to determine an orientation of a user's head. A further example gaze sensor 207 includes a visible light camera sensor to capture images including the user's eyes. The processing system 208 may determine the location of a pupil or iris within the identified eye to determine a user's gaze location. While some example gaze sensors 207 are described, any suitable gaze sensor 207 may be used in determining a user's gaze.

In some other implementations, the sensing region 202 may be separate from the display 106. For example, the sensing region 202 may be provided by a touch sensor separate from the display 206 (such as a touchpad or mouse).

FIG. 3A illustrates an example configuration of a device 300 with a touch sensor (touchpad 302) separated from a display 306. In the example of FIG. 3A, the example device 300 is depicted as a laptop computer generally comprising a touchpad 302, a keyboard 305, a display 306, and a gaze sensor 307. The display 306 may display a GUI to the user to operate the device 300. The example GUI in FIG. 3A includes a word processing window and a cursor 304.

The touchpad 302 may be an example embodiment of the touch sensor 102 of FIG. 1. In some aspects, the touchpad 302 may be configured to control the cursor 304 or other suitable operations via the GUI (such as multiple finger input, including pinching for zoom, two-finger swiping for scroll, etc.). The touchpad 302 may or may not include buttons. In some implementations, the touchpad 302 is a force touchpad configured to detect an amount of force applied by an input object in addition to detecting a position of the touch or contact by the input object.

When a user is typing on the keyboard 305 to insert text (such as “Sample Text” in the example), the user's palm may strike or rest on a portion of the touchpad 302. The device 300 may identify such touch as an input. As illustrated, the cursor is hovering over a button (depicted as an “x” in upper-right corner of the display 306) to close the word processing window in the GUI. The identified input on the touchpad 302 may cause the device 300 to close the window based on the location of the cursor.

Aspects of the present disclosure recognize that, when a user is engaged with a specific portion of the GUI, the user will look at that portion of the GUI or the input component. For example, when a user is typing, the user may look at the keyboard 305 or the portion of the display 306 where text is being inserted. The device 300, via the gaze sensor 307, may identify which portion or region of the display 306 is gazed by the user during the identified input to the touchpad 302. The gaze sensor 307 may be an example embodiment of the gaze sensor 104 of FIG. 1. The device 300 may also determine whether the user is looking away from the display 306 or the device 300.

As shown in FIG. 3A, when the user is inserting text, images of the user's eyes 308 may be captured by the gaze sensor 307 (such as a camera). The images or other scanned information are used by the device 300 to determine that the gaze of the user is directed to region 312 of the display 306. If the touchpad 302 is incidentally contacted by the user, the device 300 may determine to ignore or disregard an input detected via the touchpad 302 since the region 312 of the display 306 does not coincide with the cursor 304. Additionally or alternatively, the device 300 may determine that the user's gaze is outside of the region 310 coinciding with the cursor 304, and the device 300 may ignore or disregard an input to the touchpad 302.

FIG. 3B illustrates an example configuration of the device 300, where the user is gazing at region 310 instead of region 312 of the display 306 (as shown in FIG. 3A). When the user is using the touchpad 302, the user may gaze at the location of the cursor 304 or the portion of the GUI with which the user desires to interact. In the example of FIG. 3B, if the touchpad 302 receives a touch input with the cursor 304 hovering over the close window button, the device 300 may use the gaze sensor 104 to determine that the user is gazing at region 310 coinciding with the close window button and the cursor 304. Since the user's gaze is directed to the region of the display 306 including the GUI portion for interaction (e.g., the close window button), the device 300 may determine that the touch input is intentional and therefore perform an operation based on the touch input (e.g., close the word processing window).

While “touch input” is used in describing sensing in a sensing region, “touch input” may refer to an object in close proximity to a portion of the sensing region (such as a finger hovering over a touchpad or touch-sensitive display), and the term “touch input” does not require physical contact.

In some aspects, the device 300 may be configured to selectively perform one or more operations in response to a touch input and based on the user's gaze. For example, the device 300 may be configured to selectively filter one or more touch inputs based on the user's gaze (such as disregarding a touch input based on the user's gaze location). Other examples of one or more operations to be performed by the device 300 include adjusting one or more device or display parameters and reducing the number of operations to be performed by the device 300, in response to the touch input, based on the user's gaze.

Adjusting one or more parameters of a device or display may include dimming (or otherwise adjusting the intensity of) portions of the display 306 outside of the region at which the user is gazing, or adjust other features of a portion of the display, including the frame rate, resolution, color palette, etc. An example of reducing the number of operations may include preventing a window from being closed (such as in the example for FIG. 3A) when the user's gaze location does not coincide with the close window button while dimming a portion of the display 306 outside of the display region of the user's gaze location.

In some implementations, the device 300 may selectively perform one or more operations also based on the type of touch input received. Some types of touch inputs may be associated with using gaze location to confirm whether an operation is to be performed, and other types of touch inputs may not be associated with using gaze location. For example, when a user is reading an article and using two fingers to swipe in a sensing region for the touchpad 302, the user may be reading and not looking at a specific portion of the display 306 associated with the scrolling (e.g., a scroll bar, cursor, scroll button, etc.). In this manner, the device 300 may identify a two-finger swipe associated with scrolling and determine not to use the user's gaze location for purposes of performing or determining whether to perform a scroll operation. In another example, the display 306 may display a picture, and the user may use a two-finger pinch in the sensing region of the touchpad 302 to zoom the picture in or out. The device 300 may identify a two-finger pinch associated with zoom and determine not to use the user's gaze location for purposes of zooming or determining whether to zoom the picture. In other implementations, the user's gaze location may be used to adjust a speed of the scrolling or on which portion of a picture to zoom. For example, the device 300 may be configured to perform a slower scroll down when the user gazes at an upper portion of the display 306, and the device 300 may be configured to perform a faster scroll down when the user gazes at a lower portion of the display 306.

The operation(s) to be performed based on a type of touch input may also differ based on an application being executed or a current operation of the GUI or device 300. In some implementations, a same type of touch input may cause a device to perform different operations for different programs. For example, a swipe gesture while playing a first person point-of-view (POV) game may cause a character to change orientations, a swipe gesture while viewing pictures may cause cycling through which pictures are to be displayed, a swipe gesture while reading a news article in a web browser may cause the article to scroll, and a swipe gesture while using a cursor of the GUI may cause movement of the cursor. In some implementations, determining whether to base performing one or more operations on a user's gaze may be based on the application being executed or current operating state of the device 300. For example, when a user is moving the cursor 304 via a touch input to the touchpad 302, the device 300 may determine to base moving the cursor 304 on a user's gaze. In another example, when a user is scrolling a news article in a web browser via a touch input to the touchpad 302, the device 300 may not base whether to scroll on the user's gaze. In a further example, the device 300 may prevent basing performing one or more operations on a user's gaze when the device 300 is in a low power or power saving mode.

In addition, or alternative, to determining whether to base performing one or more operations on a user's gaze based on the type of touch input or an operating state of the device or GUI, the device 300 may determine whether to base performing one or more operations based on a user's gaze based on the force of a touch. It is noted that unintentional touches (such as grazing the touchpad 302, resting a palm on the touchpad 302, incidentally tapping a corner of a touch-sensitive display with a thumb, etc.) may be less forceful than intentional touches. The touchpad 302 (or other suitable touch sensor) may be configured to determine a force of a touch. For example, the touchpad 302 may be a force touchpad configured to determine a force of a touch.

In some implementations, the device 300 may measure the force of the touch and compare the force to a threshold. In an example, if the force is greater than the threshold, the touch may be considered intentional, and the device 300 may perform one or more operations regardless of the user's gaze. If the force is less than the threshold, the touch may be considered unintentional, and the device 300 may base performing one or more operations on the user's gaze. In another example, the force threshold may be used to determine whether a touch input is to be disregarded irrespective of the user's gaze. In a further example, the threshold may include one or more sub-thresholds associated with confidences of performing the one or more operations, which may be used in determining how much to rely on features of a user's gaze for performing the one or more operations. The threshold (or sub-thresholds) may be static or variable. In some embodiments, the threshold may be adjusted based on an application being executed or an operating state of the GUI or device 300. For example, the threshold may be higher if the device 300 is playing a video on the display 306 than if the device 300 is in an idle state. In some other embodiments, the device 300 may determine through user feedback and continued use whether to adjust the force threshold or sub-thresholds. The device 300 may be configured to use both the type of touch input and the force of the touch in determining whether to perform one or more operations should be based on a user's gaze.

In some aspects, the device 300 may vary the force threshold based on the type of touch input. For example, swipes may be associated with a lower force threshold than taps in the sensing region of the touchpad 302. The device 300 may also vary the threshold based on the type of touch in relation to the current operating of the GUI or device 300 (such as a specific program being executed or whether the device 300 is in a power save state).

In some further implementations, basing performing one or more operations on the force of the touch may be based on whether the user is interacting exclusively with the touch sensor 102 or interacting with other input components of the device 100. For example, a threshold for the force of the touch may depend on whether the user is interacting exclusively with the touch sensor 102 or interacting with other input components of the device 100. The device 300 may thus be configured to adjust when to disregard a touch input via the touchpad 302 when the user is typing on the keyboard 305 (FIG. 3A).

The device 300 may selectively perform one or more operations based on parameters other than a gaze location, a touch input type, a touch input force, and an operating state of the GUI or device 300. In some implementations, the device 300 may also determine a touch input duration. Performing one or more operations may thus be based on the duration of the touch input. For example, if a touch input duration is greater than a threshold, the touch input may be assumed to be incidental (such as the user resting a palm on the touchpad 302), and the device 300 may disregard the touch input. Similar to the force threshold, the touch input duration threshold may be static or dynamic and based on, e.g., the type of touch input, the force of the touch, the gaze location, or the operating state of the GUI or the device 300.

In some other implementations, the device 300 may also be configured to determine a duration of the user's gaze at a specific location. For example, if a user is scanning different regions of the display 306, the user may look at a specific region of the display 306 corresponding to an operation to be performed for only a brief amount of time. The device 300 may be configured to determine the duration of a user's gaze at a specific location, and/or the device 300 may be configured to determine whether the location of the user's gaze is changing. In some implementations, the device 300 may determine whether the duration of a user's gaze at a specific location or region of the display is greater than a threshold amount of time, indicating that the gaze location is intentional (instead of a brief glimpse when scanning the display 306). Similar to the force threshold, the time threshold may be static or dynamic, and may depend on the type of touch input, the force of the touch, the duration of the touch input, the gaze location, or the operating state of the GUI or device 300. In this manner, the device 300 may be configured to perform one or more operations (such as disregarding a touch input) based on the gaze duration.

In some other implementations, the device 300 may use the gaze sensor 307 or another suitable sensor to determine one or more user gestures other than a user's gaze location and duration. For example, when a user is gazing at a specific region of a GUI on the display 306, the user may lean into or otherwise move his or her head closer to the display 306. If the gaze sensor 307 or another sensor is configured to determine depths (such as using an IR camera sensor to capture IR signal reflections from the user), the device 300 may determine that the user is moving his or her head closer to the display 306. In response to identifying such a gesture, the device 300 may reinforce that the user's subsequent gaze location is intentional. Other suitable characteristics of a user's gaze, such as the visible portion of the eyes increasing or decreasing in size (i.e., opening the eyes wide or squinting), tilt of the eyes (i.e., whether the head is tilted), whether one eye is closed, etc., may be determined and used in basing whether to perform one or more operations in response to a touch input.

Another user gaze feature may be the existence, or non-existence, of a user's gaze. In some implementations, the device 300 may be configured to determine whether one or more user gaze features are able to be detected. For example, a user may wear eyeglasses or other eyewear that may prevent the gaze sensor 307 from detecting a user's eyes 308, a user's gaze location, or other user gaze features. If a user's eyeglasses cause occlusions or otherwise prevent a gaze sensor 307 from detecting a user's gaze features, the device 300 may prevent using gaze detection in performing one or more operations. In some aspects, the device 300 may notify the user (such as per a visual notification via the display 306) that a gaze could not be detected and/or gaze detection is not currently in use.

In another example, multiple people (or animals) may be within a field of view of the gaze sensor 307, and their gaze may be confused with a user's gaze. As a result, the gaze sensor 307 may sense multiple gazes (such as multiple gaze locations, multiple gaze durations, etc.), and the device 300 may be unable to determine a user's gaze. In some aspects, if the device 300 is unable to determine the user's gaze from multiple gazes, the device may prevent using gaze detection in performing one or more operations. In some other aspects, the device 300 may be configured to determine gaze features for multiple gazes and use the features in performing one or more operations. For example, if ever gaze is located on a window of multiple windows on the display 306, the device 300 may determine to maximize the window. In another example, the device 300 may discern a user from multiple people in the field of view of the gaze sensor 307 based on the gaze features and the operation of the device 300. For example, a user typing may gaze at the text being typed on the display while others may gaze at other portions of the display 306. In this manner, the device 300 may determine that the user is associated with the gaze concentrated on the text being typed. Such determination may be used when features of a user's gaze are to be used in performing one or more operations.

In a further examples, no eyes may be within the field of view of a gaze sensor, and the device 300 may not determine features of a user's gaze. For example, if the device including a touch sensor and a gaze sensor is a smartphone (with the gaze sensor being a front facing camera and the touch sensor being a touch sensitive display), the user may place the smartphone to his or her ear when making a phone call. When the phone is placed to the user's ear, the user's cheek may touch or rest on the display. If the touch sensitive display is still active, the user's cheek may press a soft button on the display (such as a number key) and cause an unintended operation (such as a loud beep during the phone call). However, when the phone is placed to the user's ear, the user's gaze is not within the field of view of the front facing camera (the user's ear and side of the head blocks the front facing camera from sensing a user's gaze). In some implementations, a device may be configured to disregard a touch input from the user (such as a touch from the cheek) when a user's gaze is not detected. For example, when a smartphone is conducting a phone call, the smartphone may disregard a touch input from a user (such as a cheek touch) when a user's gaze is not detected. When a user's gaze is detected, the smartphone is not placed against the user's ear, and the user may intend to interact with the smartphone display. Therefore, the smartphone may perform the operations associated with the user's touch when the gaze is detected (such as a user opening a web browser during a phone call). In another example, the smartphone or other suitable communication device may disable the touch-sensitive display when the user's gaze is not detected, and/or the smartphone may enable the touch-sensitive display when the user's gaze is detected during a phone call.

A combination of the touch input type, touch force, touch input duration, gaze existence, gaze location, gaze duration, operating status of the device or GUI, and/or other features of a user's gaze and touch input may be used in basing performing one or more operations (such as disregarding a touch input or performing an operation associated with the GUI). For example, the device 300 may determine the existence of a user's gaze (e.g., the device 300 may identify the user's eyes and thus be able to determine other features of a user's gaze, such as a gaze location). The device 300 may also determine a gaze location of the user to coincide with a region of the display 306, a user's gaze duration at the location to be greater than a threshold, a touch input duration to be less than a threshold, a force of the touch to be greater than a threshold, and a touch input type to be associated with an operation of a program being executed by the device for interface via the GUI and dependent on a user's gaze. The device 300 may perform the operation in response to meeting the conditions for the gaze, touch input, and operating state of the device or GUI.

In some implementations, the conditions for one or more features (such as a user's gaze location or duration) may be adjusted based on other features (such as a type of touch input or force of a touch). For example, if the gaze duration is greater than a threshold, the device 300 may expand the size of the region of the display 306 associated with the gaze location. In another example, if the force of the touch is greater than a threshold, the device 300 may expand the region of the display 306 associated with the gaze location. In another example, the distance between the region of the display 306 gazed by the user and the portion of the GUI on the display 306 associated with an operation for the touch input may be used in determining one or more thresholds for, e.g., the force of a touch or a gaze duration. For example, the device 300 may increase the force threshold as the space between the region gazed and the portion of the GUI displayed increases. Other suitable means of adjusting conditions of features for basing performing one or more operations (such as disregarding a touch input, excluding an operation from being performed, or adjusting a display brightness) are also contemplated, and the present disclosure is not limited to the provided examples.

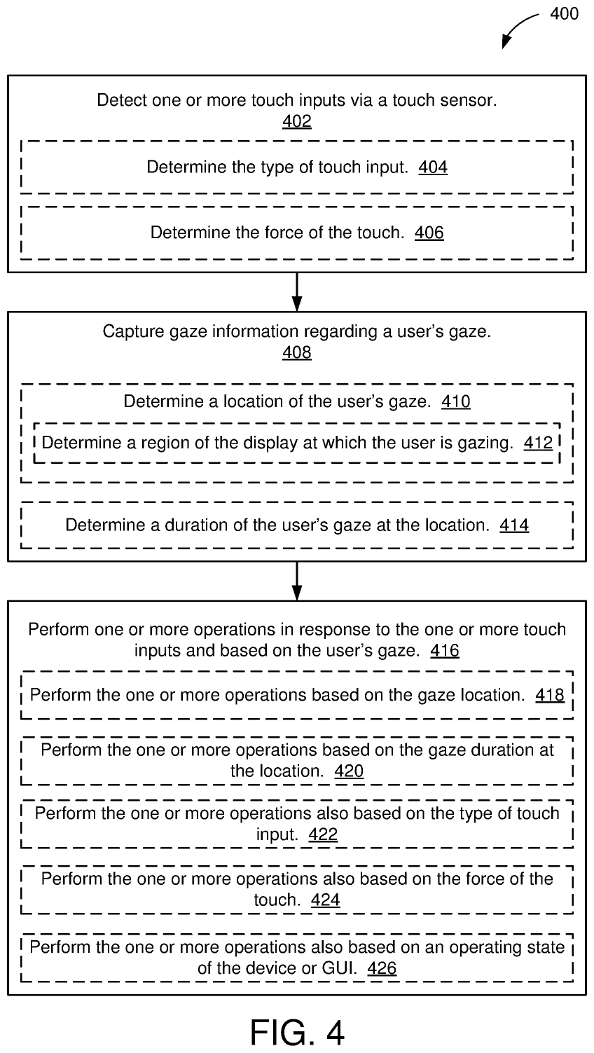

FIG. 4 is an illustrative flow chart of an example operation 400 to selectively perform one or more operations based on a user's gaze. The example operation 400 may be performed by the device 100 (in FIG. 1), such as the device 300 in FIGS. 3A and 3B or the configuration in FIG. 2. At 402, the device 100 may detect a touch input via the touch sensor 102 (such as the user touching a touchpad or touch-sensitive display or hovering an input object 204 over a touchpad or touch-sensitive display). In some implementations, the device 100 may determine the type of touch input (404) and/or determine the force of the touch (406), as described above.

The device 100 may also capture gaze information regarding a user's gaze (408). In some implementations of capturing gaze information, the device 100 may determine a location of the user's gaze (410). In some examples, the device 100 may use the gaze sensor 104 to determine a region of the display 106 at which the user is gazing (412). For example, referring back to FIG. 3A, with the user gazing at region 302 of the display 106, the device 100 may determine that the user is not gazing at region 310 of the display including the close window button and the cursor 304 associated with closing the window based on the touch sensed or received by the touch sensor 102. In some other examples, the device 100 may determine whether the user is gazing at the display or may determine whether the user is gazing at the device 100.

In some implementations capturing gaze information, the device 100 may also determine a duration of the user's gaze at the location (414). For example, the device 100 may determine whether the duration of the user's gaze at the location is greater than a threshold.

After detecting one or more touch inputs (402) and capturing gaze information (410), the device 100 may perform one or more operations in response to the one or more touch inputs and based on the user's gaze (420). In some implementations, performing the one or more operations may be based on the gaze location (418). For example, referring to FIG. 3B, the device 300 may close the window based on the location of the user's gaze being at region 310 of the display 306 and in response to detecting a touch input via the touchpad 302. If the user is not gazing at region 310, the device 300 may disregard one or more of the detected touch inputs based on the user's gaze location.

In some implementations, performing the one or more operations may also be based on the gaze duration at the location (420). For example, referring to FIG. 3B, the device 300 may close the window based on the location of the user's gaze being at region 310 of the display 306 for greater than a duration threshold and in response to detecting a touch input via the touchpad 302. If the user is not gazing at region 310 for greater than the duration threshold, the device 300 may disregard one or more of the detected touch inputs based on the gaze duration.

In some implementations, performing the one or more operations may also be based on one or more of: the type of touch input (422); the force of the touch (424); or an operating state of the device 100 or GUI (426). For example, a touch input may be associated with multiple operations to be performed based on a user's gaze location. For example, disregarding a touch input may be based on the force of the touch, a type of touch input, and/or an application of the GUI in addition to the user's gaze.

In some other example implementations, a user's gaze may not be used for specific applications or operating state of the GUI or device 100, specific types of touch inputs, and/or touches with or without a specific amount of force. For example, the device 100 may determine not to use the gaze sensor 104 if, e.g., the device 100 is in a power save mode and the gaze sensor 104 is powered down or otherwise in a power save state. The device 100 may therefore base performing one or more operations exclusively on the touch input type, the force of the touch, and/or an operating state of the device or GUI. For example, disregarding a touch input may not be based on a user's gaze in some instances. In another example, the device 100 may determine not to base performing one or more operations on a gaze location or duration if the device 100 detects multiple gazes or is unable to detect a user's gaze (e.g., if the user wears sunglasses interfering with the gaze sensor 104).

Other example operations for control using touch input and a user's gaze exist, and the disclosure is not limited to the above examples. For example, if the user's gaze is directed to the keyboard 305 of the device 300 (in FIG. 3A), a keyboard backlight or other light may be turned on or off in response to detecting a touch input. A different operation may be performed in response to the touch input when the user gazes at the display (such as closing a window or another GUI function), and as such the device 100 may determine which operation to perform in response to the detected touch input based on the location of the user's gaze. In another example, a user may search for letters on a keyboard while typing. The device 300 may be configured to determine at which key or sequence of keys the user is gazing. The user's gaze location at a specific key or sequence of keys on a keyboard may be used to perform, e.g., word prediction, spelling correction, other word processing operations, or other suitable device operations.

Those of skill in the art will appreciate information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. Those of skill in the art will appreciate that other suitable implementations for combining touch input sensing and gaze sensing in performing one or more operations (such as disregarding a touch input) may be used. The specification and drawings are, accordingly, to be regarded in an illustrative sense rather than a restrictive sense.

1. A device, comprising:
a touch sensor configured to sense a touch input from a user;
a gaze sensor configured to capture gaze information regarding a user's gaze;
one or more processors; and
a memory coupled to the one or more processors, the memory storing instructions that, when executed by the one or more processors, cause the device to:
determine a gaze duration of the user's gaze based on the captured gaze information; and
disregard the touch input based on the gaze duration of the user's gaze.

2. The device of claim 1, wherein execution of the instructions further causes the device to:
determine a gaze location of the user's gaze based on the captured gaze information, wherein disregarding the touch input is also based on the gaze location.

3. (canceled)

4. The device of claim 2, wherein execution of the instructions further causes the device to:
determine a type of the touch input, wherein disregarding the touch input is further based on the type of the touch input.

5. The device of claim 2, wherein execution of the instructions further causes the device to:
determine a force of the touch input, wherein performing the device operation is further based on the force of the touch input.

6. The device of claim 5, wherein the touch sensor includes a force touchpad and the gaze sensor includes a camera.

7. The device of claim 2, wherein performing the device operation is further based on an operating state of the device.

8. The device of claim 1, wherein execution of the instructions further causes the device to:
determine whether the user's gaze is detected, wherein disregarding the touch input is based on whether the user's gaze is detected.

9. A non-transitory, computer readable medium storing instructions that, when executed by one or more processors of a device, cause the device to:
sense, by a touch sensor, a touch from a user;
capture, by a gaze sensor, gaze information regarding a user's gaze;
determine, by one or more processors, a gaze duration of the user's gaze based on the captured gaze information; and
disregard the touch input based on the gaze duration of the user's gaze.

10. The computer readable medium of claim 9, wherein the instructions further cause the device to:
determine a gaze location of the user's gaze based on the captured gaze information, wherein disregarding the touch input is also based on the gaze location.

11. (canceled)

12. The computer readable medium of claim 10, wherein the instructions further cause the device to:
determine a type of the touch input, wherein disregarding the touch input is further based on the type of the touch input.

13. The computer readable medium of claim 10, wherein the instructions further cause the device to:
determine a force of the touch input, wherein disregarding the touch input is further based on the force of the touch input.

14. The computer readable medium of claim 10, wherein disregarding the touch input is further based on an operating state of the device.

15. The computer readable medium of claim 10, wherein the instructions further causes the device to:
determine whether the user's gaze is detected, wherein disregarding the touch input is based on whether the user's gaze is detected.

16. A method, comprising:
sensing, by a touch sensor, a touch from a user;
capturing, by a gaze sensor, gaze information regarding a user's gaze;
determining, by one or more processors, a gaze duration of the user's gaze based on the captured gaze information; and
disregarding the touch input based on the gaze duration of the user's gaze.

17. The method of claim 16, further comprising:
determining a gaze location of the user's gaze based on the captured gaze information, wherein disregarding the touch input is also based on the gaze location.

18. (canceled)

19. The method of claim 17, further comprising:
determining at least one of a type of the touch input or a force of the touch input, wherein disregarding the touch input is further based on at least one of the type of the touch input or the force of the touch input.

20. The method of claim 17, further comprising:
determining whether the user's gaze is detected, wherein disregarding the touch input is based on whether the user's gaze is detected.

21. The device of claim 2, wherein execution of the instructions further causes the device to:
adjust a display region associated with the touch input and the gaze location based on the gaze duration, wherein disregarding the touch input is based on the gaze location being outside of the adjusted display region.

22. The computer readable medium of claim 10, wherein the instructions further cause the device to:
adjust a display region associated with the touch input and the gaze location based on the gaze duration, wherein disregarding the touch input is based on the gaze location being outside of the adjusted display region.

23. The method of claim 17, further comprising:
adjust a display region associated with the touch input and the gaze location based on the gaze duration, wherein disregarding the touch input is based on the gaze location being outside of the adjusted display region.
